(19) United States
(12) Patent Application Publication
(10) Pub. No.: US 2026/0122602 A1
(43) Pub. Date: Apr. 30, 2026

(54) METHOD, APPARATUS AND COMPUTER PROGRAM

(71) Applicant: Nokia Technologies Oy, Espoo (FI)

(72) Inventors: Oana-Elena BARBU, Aalborg (DK); Diomidis MICHALOPOULOS, Munich (DE)

(21) Appl. No.: 19/117,779

(22) PCT Filed: Sep. 12, 2023
(86) PCT No.: PCT/EP2023/074943

§ 371 Date: Apr. 2, 2025

(30) Foreign Application Priority Data
Oct. 14, 2022 (GB) 2215171.6

(51) Int. Cl. H04W 64/00; H04B 7/06; H04L 25/02

(52) U.S. Cl. CPC H04W 64/00; H04B 7/0639; H04L 25/0212

(57) ABSTRACT

An apparatus including means for sending a request message to one or more network nodes. The request message includes a request for channel information related to one or more communication links of one or more second user devices. The apparatus includes means for, based on the channel information, determining a first signalling configuration related to a positioning link of a first user device. The apparatus includes means for sending the first signalling configuration to the first user device.

### FIELD

The present application relates to a method, apparatus, and computer program and in particular but not exclusively to a communication system. More particularly, the present application relates to signalling configurations in an on-demand positioning method, apparatus and computer program.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect there is provided an apparatus comprising: means for sending a request message to one or more network nodes, the request message comprising a request for channel information related to one or more communication links of one or more second user devices; and means for, based on the channel information, determining a first signalling configuration related to a positioning link of a first user device; and means for sending the first signalling configuration to the first user device.

According to some examples, the apparatus comprises means for determining one or more second signalling configurations related to the one or more communication links of the one or more second user devices, and means for sending the one or more second signalling configurations to the one or more second user devices.

According to some examples, the first signalling configuration and the one or more second signalling configurations are configured for a same one or more radio resources.

According to some examples, the first signalling configuration comprises a signal transformation for transmitted and/or received signals of the first user device, and the one or more second signalling configurations comprise a signal transformation for transmitted and/or received signals of the one or more second user devices, the first and second signalling configurations arranged to minimise interference between the positioning link of the first user device and the one or more communication links of the second user devices.

According to some examples, the first signalling configuration includes a first precoder matrix and/or a first combining matrix, and the one or more second signalling configurations include a second precoder matrix and/or a second combining matrix.

According to some examples, the channel information comprises one or more of: channel state information; channel impulse response; channel frequency response.

According to some examples, the apparatus further comprises means for determining location information of the first user device, and means for using the location information to determine the one or more network nodes.

According to some examples, the location information comprises one or more of: serving beam information; cell sector information; information of distance to cell edge.

According to some examples, the one or more second user devices are proximate to the first user device, wherein the one or more second user devices are considered proximate if they one or more of: share a serving beam with the first user device; have a serving beam adjacent to a serving beam of the first user device; are in an adjacent cell-sector to the first user device.

According to some examples, the apparatus comprises means for receiving a localization request for the first user device that is served by a network node.

According to some examples, the first signalling configuration is sent directly to the first user device and the second signalling configuration is sent directly to the one or more second user devices, or via first and second network nodes respectively.

According to some examples, the means comprises at least one processor and at least one memory storing instructions to be executed by the processor.

According to some examples, the apparatus comprises a location management function.

According to a second aspect there is provided an apparatus comprising: at least one processor; and at least one memory storing instructions that, when executed by the at least one processor, cause the apparatus at least to perform: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to a third aspect there is provided a method comprising: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to some examples, the method comprises determining one or more second signalling configurations related to the one or more communication links of the one or more second user devices, and sending the one or more second signalling configurations to the one or more second user devices.

According to some examples, the first signalling configuration and the one or more second signalling configurations are configured for a same one or more radio resources.

According to some examples, the first signalling configuration comprises a signal transformation for transmitted and/or received signals of the first user device, and the one or more second signalling configurations comprise a signal transformation for transmitted and/or received signals of the one or more second user devices, the first and second signalling configurations arranged to minimise interference between the positioning link of the first user device and the one or more communication links of the second user devices.

According to some examples, the first signalling configuration includes a first precoder matrix and/or a first combining matrix, and the one or more second signalling configurations include a second precoder matrix and/or a second combining matrix.

According to some examples, the channel information comprises one or more of: channel state information; channel impulse response; channel frequency response.

According to some examples, the method comprises determining location information of the first user device, and using the location information to determine the one or more network nodes.

According to some examples, the location information comprises one or more of: serving beam information; cell sector information; information of distance to cell edge.

According to some examples, the one or more second user devices are proximate to the first user device, wherein the one or more second user devices are considered proximate if they one or more of: share a serving beam with the first user device; have a serving beam adjacent to a serving beam of the first user device; are in an adjacent cell-sector to the first user device.

According to some examples, the method comprises receiving a localization request for the first user device that is served by a network node.

According to some examples, the first signalling configuration is sent directly to the first user device and the second signalling configuration is sent directly to the one or more second user devices, or via first and second network nodes respectively.

According to some examples, the method is carried out by a location management function.

According to a fourth aspect there is provided a computer program comprising instructions for causing an apparatus to perform at least the following: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to a fifth aspect there is provided a computer program comprising instructions stored thereon for performing at least the following: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to a sixth aspect there is provided a non-transitory computer readable medium comprising program instructions for causing an apparatus to perform at least the following: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to a seventh aspect there is provided a non-transitory computer readable medium comprising program instructions stored thereon for performing at least the following: sending a request message to one or more network nodes, the request message comprising a request for channel information related to one or more communication links of one or more second user devices; based on the channel information, determining a first signalling configuration related to a positioning link of a first user device; and sending the first signalling configuration to the first user device.

According to an eighth aspect there is provided an apparatus comprising: means for receiving, from a network node, a request for channel information of one or more user devices served by the apparatus; means for, in response to receiving the request, generating the channel information for the one or more user devices, means for sending the channel information to the network node; means for receiving, from the network node, information of a signalling configuration to be adopted by the one or more user devices served by the apparatus.

According to some examples, the apparatus comprises means for sending the information of a signalling configuration to the one or more user devices.

According to some examples, the signalling configuration comprises a signal transformation for transmitted and/or received signals of the one or more user devices served by the apparatus.

According to some examples, the signalling configuration comprises information of a precoder and/or combining matrix to be applied by the one or more user devices.

According to some examples, the apparatus further comprises means for sending an acknowledgement to the network node acknowledging receipt of the precoder and/or combining matrix, the acknowledgement comprising information of how many slots the precoding and/or combining matrix will be active for.

According to some examples the apparatus comprises means for, in response to receiving the request, reporting one or more of the following to the network node in an information element: the channel information; identification information of the one or more user devices served by the apparatus; information of type of link between the apparatus and the one or more user device served by the apparatus, the type of link comprising a positioning link or a communication link; information of precoding capability.

According to some examples, the information element is sent as part of NRPPa signalling.

According to some examples, the sending channel information comprises sending differential channel information.

According to some examples the network node comprises a location management function.

According to some examples the means comprises at least one processor and at least one memory storing instructions to be executed by the processor.

According to some examples, the apparatus comprises a base station.

According to a ninth aspect there is provided an apparatus comprising: at least one processor; and at least one memory storing instructions that, when executed by the at least one processor, cause the apparatus at least to perform: receiving, from a network node, a request for channel information of one or more user devices served by the apparatus; in response to receiving the request, generating the channel information for the one or more user devices, sending the channel information to the network node; receiving, from the network node, information of a signalling configuration to be adopted by the one or more user devices served by the apparatus.

According to a tenth aspect there is provided a method comprising: receiving, from a network node, a request for channel information of one or more user devices served by an apparatus; in response to receiving the request, generating the channel information for the one or more user devices, sending the channel information to the network node; receiving, from the network node, information of a signalling configuration to be adopted by the one or more user devices served by the apparatus.

According to some examples, the method comprises sending the information of a signalling configuration to the one or more user devices.

According to some examples, the signalling configuration comprises a signal transformation for transmitted and/or received signals of the one or more user devices served by the apparatus.

According to some examples, the signalling configuration comprises information of a precoder and/or combining matrix to be applied by the one or more user devices.

According to some examples, the method comprises sending an acknowledgement to the network node acknowledging receipt of the precoder and/or combining matrix, the acknowledgement comprising information of how many slots the precoding and/or combining matrix will be active for.

According to some examples the method comprises, in response to receiving the request, reporting one or more of the following to the network node in an information element: the channel information; identification information of the one or more user devices served by the apparatus; information of type of link between the apparatus and the one or more user device served by the apparatus, the type of link comprising a positioning link or a communication link; information of precoding capability.

According to some examples, the information element is sent as part of NRPPa signalling.

According to some examples, the sending channel information comprises sending differential channel information.

According to some examples the network node comprises a location management function.

According to some examples, the method is performed by a base station.

According to an eleventh aspect there is provided a computer program comprising instructions for causing an apparatus to perform at least the following: receiving, from a network node, a request for channel information of one or more user devices served by the apparatus; in response to receiving the request, generating the channel information for the one or more user devices, sending the channel information to the network node; receiving, from the network node, information of a signalling configuration to be adopted by the one or more user devices served by the apparatus.

According to a twelfth aspect there is provided a computer program comprising instructions stored thereon for performing at least the following: receiving, from a network node, a request for channel information of one or more user devices served by an apparatus; in response to receiving the request, generating the channel information for the one or more user devices, sending the channel information to the network node; receiving, from the network node, information of a signalling configuration to be adopted by the one or more user devices served by the apparatus.

According to a thirteenth aspect there is provided a non-transitory computer readable medium comprising program instructions for causing an apparatus to perform at least the following: receiving, from a network node, a request for channel information of one or more user devices served by the apparatus; in response to receiving the request, generating the channel information for the one or more user devices, sending the channel information to the network node; receiving, from the network node, information of a signalling configuration to be adopted by the one or more user devices served by the apparatus.

According to a fourteenth aspect there is provided a non-transitory computer readable medium comprising program instructions stored thereon for performing at least the following: receiving, from a network node, a request for channel information of one or more user devices served by an apparatus; in response to receiving the request, generating the channel information for the one or more user devices, sending the channel information to the network node; receiving, from the network node, information of a signalling configuration to be adopted by the one or more user devices served by the apparatus.

According to a fifteenth aspect there is provided an apparatus comprising: means for receiving a first signalling configuration related to a positioning link associated with the apparatus, and for receiving a second signalling configuration related to a communication link associated with another device using a common subset of resources with the apparatus; and means for using the first and second signalling configurations to determine an interference management technique to be performed by the apparatus, by assessing a quality of the positioning link relative to the communication link.

According to some examples the means for using the first and second signalling configurations to determine an interference cancellation technique to be performed being configured to do so in response to determining that the received signalling configurations do not result in sufficient improvement in a quality of the positioning link, the interference cancellation technique comprising removing an effect of the communication link from the positioning link.

According to some examples the first signalling configuration comprises a precoding matrix for the positioning link of the apparatus and the second signalling configuration comprises a precoding matrix for the communication link associated with the device, and the interference cancellation technique comprises performing interference cancellation of the communication link.

According to some examples, the interference management technique comprises one or more of: interference cancellation; interference suppression.

According to some examples the means comprises at least one processor and at least one memory storing instructions to be executed by the processor.

According to some examples, the apparatus comprises a user equipment.

According to a sixteenth aspect there is provided an apparatus comprising: at least one processor; and at least one memory storing instructions that, when executed by the at least one processor, cause the apparatus at least to perform: receiving a first signalling configuration related to a positioning link associated with the apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to a seventeenth aspect there is provided a method comprising: receiving a first signalling configuration related to a positioning link associated with an apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to some examples the using the first and second signalling configurations to determine an interference cancellation technique to be performed is in response to determining that the received signalling configurations do not result in sufficient improvement in a quality of the positioning link, the interference management technique comprising removing an effect of the communication link from the positioning link.

According to some examples the first signalling configuration comprises a precoding matrix for the positioning link of the apparatus and the second signalling configuration comprises a precoding matrix for the communication link associated with the device, and the interference management technique comprises performing interference cancellation of the communication link.

According to some examples, the interference management technique comprises one or more of: interference cancellation; interference suppression.

According to some examples, the method is performed by a user equipment.

According to an eighteenth aspect there is provided a computer program comprising instructions for causing an apparatus to perform at least the following: receiving a first signalling configuration related to a positioning link associated with the apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to a nineteenth aspect there is provided a computer program comprising instructions stored thereon for performing at least the following: receiving a first signalling configuration related to a positioning link associated with an apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to a twentieth aspect there is provided a non-transitory computer readable medium comprising program instructions for causing an apparatus to perform at least the following: receiving a first signalling configuration related to a positioning link associated with the apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to a twenty first aspect there is provided a non-transitory computer readable medium comprising program instructions stored thereon for performing at least the following: receiving a first signalling configuration related to a positioning link associated with an apparatus, receiving a second signalling configuration related to a communication link associated with another device using a common subset of resources with the apparatus; using the first and second signalling configurations to determine an interference management technique to be performed by the apparatus, by assessing a quality of the positioning link relative to the communication link.

According to a twenty second aspect there is provided an apparatus comprising:
means for receiving two or more signalling configuration options for interference management at the apparatus; means for selecting one of the configuration options; and means for reporting which of the configuration options has been selected.

According to some examples, the reporting comprises reporting to one or more of: a location management function; a transmission point in communication with the apparatus.

According to some examples, the interference management technique comprises one or more of: interference cancellation; interference suppression.

According to some examples the means comprises at least one processor and at least one memory storing instructions to be executed by the processor.

According to some examples, the apparatus comprises a user equipment.

According to a twenty third aspect there is provided an apparatus comprising: at least one processor; and at least one memory storing instructions that, when executed by the at least one processor, cause the apparatus at least to perform: receiving two or more signalling configuration options for interference management at the apparatus; selecting one of the configuration options; and reporting which of the configuration options has been selected.

According to a twenty fourth aspect there is provided a method comprising: receiving two or more signalling configuration options for interference management at the apparatus; selecting one of the configuration options; and reporting which of the configuration options has been selected.

According to some examples, the reporting comprises reporting to one or more of: a location management function; a transmission point in communication with the apparatus.

According to some examples, the interference management technique comprises one or more of: interference cancellation; interference suppression.

According to some examples, the method is performed by a user equipment.

According to a twenty fifth aspect there is provided a computer program comprising instructions for causing an apparatus to perform at least the following: receiving two or more signalling configuration options for interference management at the apparatus; selecting one of the configuration options; and reporting which of the configuration options has been selected.

According to a twenty sixth aspect there is provided a computer program comprising instructions stored thereon for performing at least the following: receiving two or more signalling configuration options for interference management at an apparatus; selecting one of the configuration options; and reporting which of the configuration options has been selected.

According to a twenty seventh aspect there is provided a non-transitory computer readable medium comprising program instructions for causing an apparatus to perform at least the following: receiving two or more signalling configuration options for interference management at the apparatus; selecting one of the configuration options; and reporting which of the configuration options has been selected.

According to a twenty eighth aspect there is provided a non-transitory computer readable medium comprising program instructions stored thereon for performing at least the following: receiving two or more signalling configuration options for interference management at an apparatus; selecting one of the configuration options; and reporting which of the configuration options has been selected.

### DESCRIPTION OF FIGURES

Embodiments will now be described, by way of example only, with reference to the accompanying Figures in which:

FIG. 1 schematically shows a representation of a network system according to an example embodiment;

FIG. 2 schematically shows a method flow according to an example;

FIG. 3 schematically shows interference alignment methodology, according to an example;

FIG. 4 schematically shows a representation of a network system according to an example embodiment;

FIG. 5 is a signalling diagram according to an example;

FIG. 6A schematically shows PRB usage according to an example;

FIG. 6B schematically shows PRB usage according to an example;

FIG. 7 is a signalling diagram according to an example;

FIG. 8 is a signalling diagram according to an example;

FIG. 9 shows a representation of a control apparatus according to some examples;

FIG. 10 shows a representation of a user equipment, according to some examples;

FIGS. 11 to 14 are method flow charts according to examples;

FIG. 15 shows a representation of an apparatus according to some example embodiments.

### DETAILED DESCRIPTION

In the following, certain embodiments are explained with reference to mobile communication devices capable of communication via a wireless cellular system and mobile communication systems serving such mobile communication devices.

The present disclosure relates to positioning. More particularly, the present disclosure relates to UE positioning in a telecommunication network. For example, the present disclosure relates to determining the position or location of one or more UEs. More particularly still, the disclosure relates to “enhanced positioning”, which is being endorsed in 3GPP RAN. Also, the present disclosure relates to enhancements of network efficiency pertaining to on-demand PRS (positioning reference signal) transmissions, which is specified in the Rel-17 WID (work item description):

“Specify on-demand transmission and reception of DL PRS for DL and DL+UL positioning for UE-based and UE-assisted positioning solutions, including: [RAN2, RAN1, RAN3]
UE-initiated request of on-demand DL PRS transmission;
LMF (network)-initiated request of on-demand DL PRS transmission;”

The concept of on-demand PRS states that PRS are transmitted only to a direction where there is at least one UE which will receive and process them for deriving the location of the UE (either at the UE itself—referred to as “UE-based” positioning, or at the network side after the UE measurements are reported to the network—referred to as “UE-assisted” positioning). On-demand PRS also dictates that in case there is a need for stronger reception of PRS signals by the UE (for instance, for higher accuracy), then the network can provide increased PRS resources (for example, increased bandwidth and/or increased periodicity of PRS occasions) to the designated areas. On demand PRS has been agreed in Rel-17 (see [TS37.355, V17.0]), and is expected to play a part in Rel-19 and beyond enhanced positioning discussions as well.

A function of on-demand PRS (ODPRS) is to enable a more flexible positioning session for the target UE. This leads to improved resource utilization, since ODPRS should be configured according to the positioning QoS (latency, accuracy) and channel conditions of each UE.

Thus, to reach its full potential in terms of spectral efficiency and positioning QoS (quality of service), ODPRS resource allocation needs to be fully flexible in terms of which, how often and how many resources should be used in one session. This flexibility may be hard to achieve in practice under current specs, since until now, positioning resources have been separated from communication resources (down prioritized), and therefore, spectrum availability for positioning was severely limited. To overcome or mitigate this limitation, the present disclosure identifies a need for a framework which allows:
Merging positioning and communication resources in the same common pool.
A coordination scheme among network entities that need to access the above pool for different purposes. For example, some resources may be used for communications while other resources may be used for positioning, without down-prioritizing one service over the other.

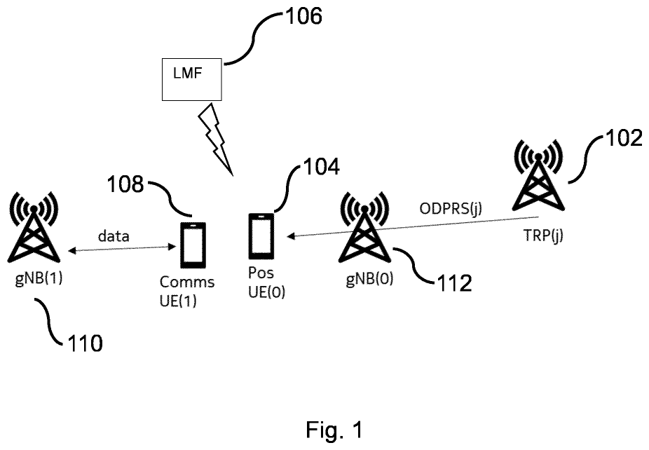

By way of further explanation, consider the scenario of FIG. 1 which shows a far-away or remote transmission-receive point (TRP) indexed j, TRP(j) 102, which has been configured to transmit ODPRS(j) at time instance N towards target UE (0) 104. In this example, j=1:J, and J is the total number of TRPs for target UE(0). In this example, the transmission configuration was finalized in advance of the actual transmission, i.e. during time instance P<N, by message exchange between the target UE(0) 104 and an LMF 106.

At the same time instance N, UE(1) 108 may be served in UL/DL by gNB(1) 110 on the same physical resource blocks (PRBs) as ODPRS(j), called PRB(j). This may happen since gNB(1) 108 is not involved in the localization session of UE(0) 104, therefore, according to the current standard, gNB(1) 110 was never informed by any network entity that a foreign UE(0) 104 is receiving ODPRS(j) in the same band. From gNB(1) 110 viewpoint, PRB(j) is available for usage, therefore can be allocated. When this situation occurs, the data link of UE(1) 108 degrades the reception quality of ODPRS at UE(0) 104, since the former signal is much stronger than the latter one.

A conservative way of mitigating the problem is to reserve PRB(j) across several (perhaps tens of) cells and have all the cells remain silent while ODPRS are sent. This may be detrimental for the network spectral efficiency and latency for the following reasons:
Spectral efficiency impact: Due to the long-range of ODPRS, the resources should be reserved across tens of cells, and not only among a reduced set of neighbors (like the typical frequency reuse schemes used in traditional network planning).
Latency impact: Target UE(0) 104 needs to wait to receive and measure ODPRS from tens of TRPs. To avoid long waiting times, many adjacent PRBs would end up being reserved for on-demand positioning purposes. This strategy is however both unfeasible and unlikely in practice, since it means that all cells need to prioritize the localization of other UEs over data traffic of their own UEs.

Therefore, to reach the full potential of ODPRS-based localization, the present disclosure identifies a need to redefine the current positioning framework to enable the joint usage of communication and positioning resources. Such framework may enable a flexible and swift on-demand localization session tailored to each individual UE.

The present disclosure proposes a Rel. 19 coordination framework for full spectrum re-use between data communications and positioning, without down-prioritizing one service over the other. The proposed framework involves acquiring and exchanging (uni- or bi-directionally) targeted channel state information (T-CSI) for different link types, where the T-CSI is subsequently used to realize or determine (uni- or bi-directional) interference alignment (IA) between the link types, so that the same resource may be simultaneously used for positioning and communications.

According to some examples, by link type is meant one or both of:
1. A communication link (CL), For example UL, DL, or sidelink (SL) traffic
2. A positioning link. For example an on-demand positioning link (OPL), such as ODPRS transmission.

To enable the full spectral reuse without down-prioritizing or degrading the quality of service (QoS) of one service over the other, the location management function (LMF) triggers IA-based positioning-communication (e.g. OPL-CL) coordination through which a set of {CL, OPL} links are spatially separated. For example, the links may be spatially separated by smart precoding and/or combining.

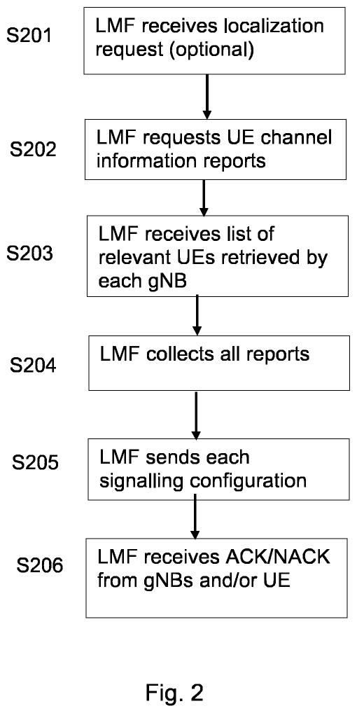

According to some examples, to realize or achieve IA, the LMF implements the steps shown schematically in FIG. 2 and described in more detail below and with respect to the example of FIG. 1. It will be understood that user equipment (UE) may also be referred to as a user device. The gNBs may also be referred to as base stations or network nodes.

In this example, at S201, the LMF 106 receives a localization request. For example the LMF 106 receives a localization request for UE(0) 104 (see FIG. 1), served by gNB(0) 112. In this example UE(0) 104 may be considered the target UE. In this example UE(0) 104 may be considered a first user equipment, and the gNB(0) 112 may be considered a first base station or a first network node. Using serving cell information, the LMF 106 obtains channel information and information of a location of UE(0) 104. In some examples the channel information comprises one or more of channel state information (CSI); channel impulse response (CIR); channel frequency response (CFR). In some examples the location information comprises coarse or approximate location information. In some examples, by “coarse location” (cl-loc) it is meant any one or more of or combination of: serving beam information; cell sector; distance to cell edge etc. According to some examples the localization request is initiated by an application requiring this service. The application may reside in the network or the UE itself.

At S202, the LMF 106 requests UE channel information reports. For example, using the cl-loc, LMF 106 asks the neighbor gNBs (such as gNB(1) 110) to report channel information regarding nearby UEs (if any) e.g. CSI for UE(1) 108. According to examples the channel information comprises one or more of: CSI; CIR; CFR. According to some examples, a “nearby UE” is defined as a UE that is close enough to the target UE(0) 104, so that they one or more of the following:
a. Share the same serving beam,
b. Their serving beams are adjacent,
c. They are in adjacent cell-sectors, etc.

For example, LMF 106 may send a request in a new information element (IE). The new IE may include the (cl-loc, target UE ID e.g. ID of UE(0) 104). The new IE may also contain information of the preferred carrier. The new IE may also contain information of bandwidth (BW) for which channel information needs to be reported. In some examples the new IE is sent over NR Positioning Protocol A (NRPPa). It is to be noted that this does not incur additional signaling overhead since the proposed new IE can be part of the existing NRPPa TRP Information Exchange process (see TS38.455, Section 8.2.8). For example, the new IE can be part of the “TRP Information Request/Response pair” as a structure per UE ID:
Cloc-info e.g. serving gNB, serving beam
Cloc-carrier
Cloc-bw.

It is to be noted that “cl-loc” and “cloc” both refer to “coarse location”, and may be used interchangeably. “Cloc-bw” relates to the bandwidth (BW) used by the UE in the same coarse location. In this regard, BW for example may be considered a type of cl-loc INFO.

According to examples, at S203, each gNB retrieves and reports a list of relevant UEs to the LMF 104, and the LMF 104 receives a list of relevant UEs retrieved by each gNB. For example, each of gNB(0) 112 and gNB(1) 110 may report on relevant UEs supported by each of the respective gNBs. The gNB(1) 110 may in this example be referred to as a second network node, and UE(1) 108 may be considered a second user equipment. In some examples the list of relevant UEs is sent in a new information element, and includes the following information:
a. The UE ID (e.g. gNB(1) 110 may provide ID of UE(1) 108).
b. the CL type (UL, DL or SL),
c. The precoding capability (type, codebook, etc.):
   i. Analog/digital/hybrid
   ii. Codebook e.g. type I or type II—see 3GPP TS 38.214 for examples.
d. The CSI of each CL. CSI can be given as:
   i. The channel impulse response (CIR) of the CL organized as a list of pairs (gain, delay), where each pair indicates the gain of the multipath component arriving at the receiver with the respective delay.
   ii. The channel frequency response (CFR) in the respective carrier and BW.
   iii. The amplitude and delay of the main channel multipath component, etc. In some examples this may be obtained from the estimated CIR (see i.) by selecting the strongest detected component.

In some examples the new IE is sent via NRPPa.

It is to be noted that in some examples the definition of CSI for IA needs to be predefined so that all parties (e.g. UEs and gNBs) have a common understanding of what needs to be signalled and how. Again, in examples this gNB response at S203 does not entail signalling overhead as it can be part of the existing NRPPa TRP Information Exchange process.

Note that if a gNB already has a list of active UEs associated with cl-loc (for example obtained in the recent past as a result of cross-link interference identification, obtained for another positioning session, etc), then the gNB may:
a) evaluate if the most recent CSI can be considered valid for the current session as well. For example, the most recent CSI may be considered valid if the time passed between the current session and the existing entry is less than the coherence time of the channel of each UE
b) update the list by refreshing the CSI for the UEs whose information is deemed as deprecated.
c) instead of reporting the full CSI, report a shortened CSI. For example, the gNB may report differential CSI. The differential CSI may contain only the variation in CSI estimates compared to the last reporting.

At S204 the LMF 106 collects the reports. In examples, based on the collected reports the LMF 106 computes a signaling configuration for the UE(0) 104 and the UE(1) 108. In examples, the signaling configuration for the UE(0) 104 may be considered a first signaling configuration and the signaling configuration for the UE(1) 108 may be considered second signaling configuration. In examples the first signalling configuration comprises a signal transformation for transmitted and/or received signals of the UE(0) 104, and the second signalling configuration comprises a signal transformation for transmitted and/or received signals of the UE(1) 108.

In examples, the first and second signalling configurations are arranged by the LMF 106 to minimise interference between signalling of the UE(0) 104 and the UE(1) 108. In some examples the first and second signalling configurations are arranged by the LMF 106 to minimise interference between a positioning link of the UE(0) 104 and a communication link of the UE(1) 108.

In some examples, the first signalling configuration may comprise a first precoder and/or combining matrix (PM/CM) for the UE(0) 104, and the second signalling configuration may comprise a second PM and/or CM for UE(1) 108. In other words, in some examples, based on received reports from the gNBs, the LMF 106 computes precoder and/or combining matrix (PM/CM) per link. In this case, the first precoder matrix and the second precoder matrix may be the same or different from each other.

In some examples, the LMF 106 computes the PM/CM per link at least for OPL and additionally/optionally for the nearby CLs. According to examples, the computation is not limited to a particular IA strategy.

At S205 the LMF 106 sends each signaling configuration including the first or the second PM/CM (or the index to the PM/CM if the precoding is codebook-based) to the corresponding gNBs (e.g., gNB(0) 112 or gNB(1) 110), and/or directly to the target UE (e.g., UE(0) 104) or UE(1) 108) via:
a) NRPPa new IE; and/or
b) LPP (LTE positioning protocol) assistance data new IE, respectively.

At S206 the gNBs and/or transmission points and/or UEs (e.g. gNB(0) 112 and/or gNB(1) 110 and/or TRPj 102 and/or UE(0) 104 and/or UE(1) 108) respond with an ACK/NACK to the LMF 106. In some examples the ACK/NACK is sent via NRPPa in a new IE. The ACK/NACK may be dependent on whether the signaling configuration (e.g. precoding matrix and/or combining matrix) has been applied or not. In case of ACK, in some examples the gNBs also report a validity duration (VD). In some examples the VD provides information of how many slots the signaling configuration (e.g. PM) will be active per each link.

It will therefore be understood that in some examples the LMF 106 points the UEs (perhaps via the gNBs) to resources (e.g. PM/CM) that will have an effect of lessening interference between UE(0) 104 and UE(1) 108 (particularly for lessening interference between positioning links and communication links).

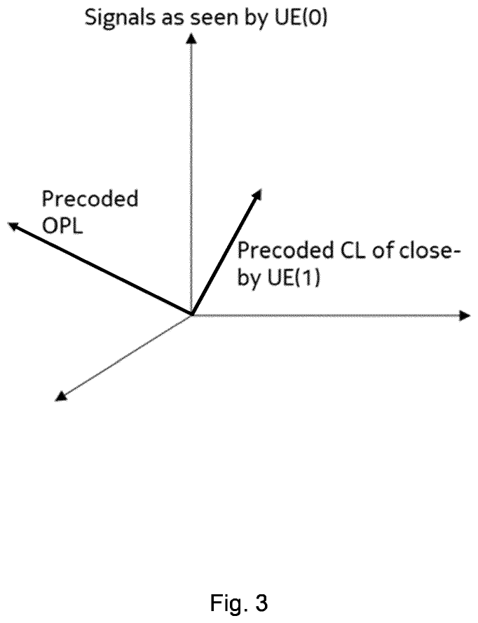

To aid with understanding of the disclosure, some aspects of interference alignment (IA) are discussed with respect to FIG. 3. The IA framework defines that, in order for a set of UE to use the same PRBs, then their signals should be precoded in such way that the signal intended for each user lies in a subspace orthogonal to the space where the sum of the remaining signals is found, as shown in FIG. 3. When this is accomplished, each user can successfully decode its own data, while perfectly rejecting the orthogonal signal sum.

To exemplify the IA concept, consider an example where a UE is receiving a sum of two signals, one desired signal X₁ and one interfering signal X₂. In this example the second signal, X₂, is pre-coded with code 1j: Y=X₁+jX₂. Then, if we assume that the signals X₁ and X₂ were purposely designed to be real-valued (i.e. real number) signals, then the UE which receives Y, can easily recover X₁ by simply discarding the imaginary part of Y, i.e. (\hat{X}₁)=Y-Imag{Y}. The recovery is perfect because X₁ and X₂ have been orthogonalized in code at the two transmitters. In practice, the signals are sent over a multipath wireless propagation channel, therefore, to orthogonalize them, CSI associated with each signal is required at each transmitter.

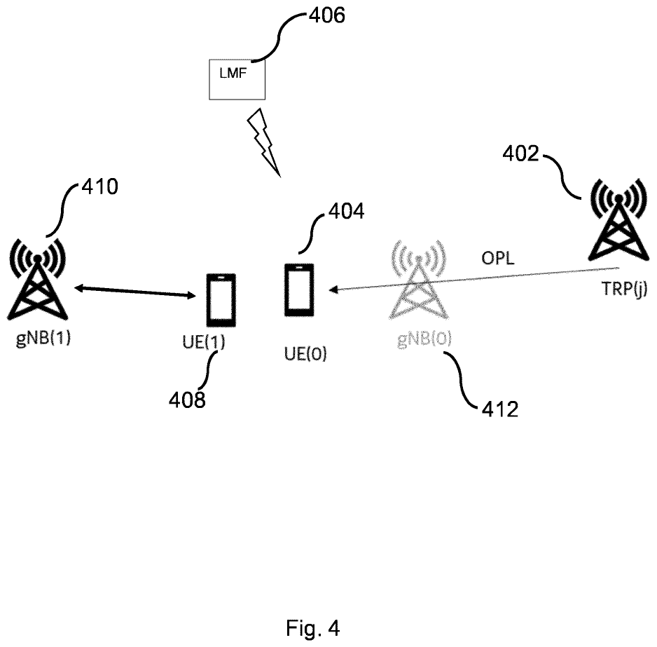

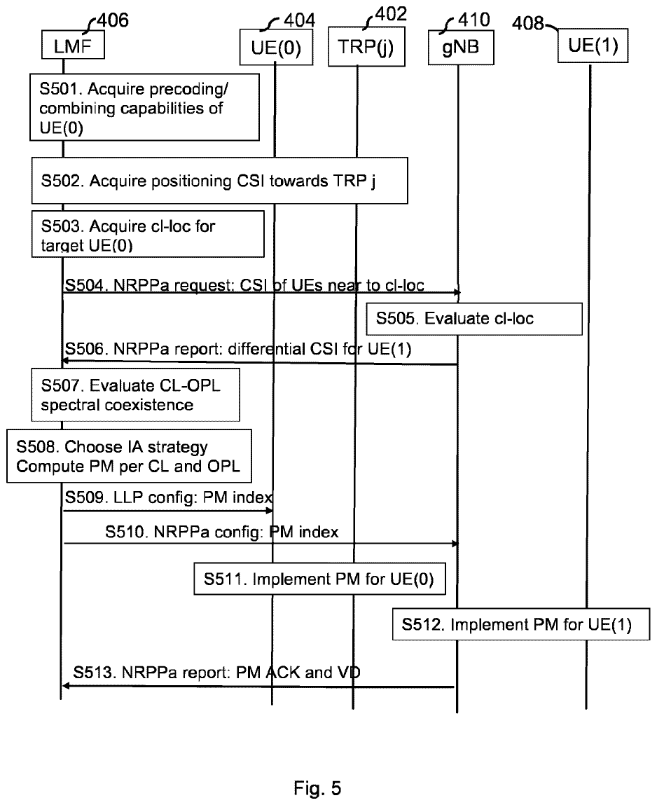

Considering the example scenario from FIG. 4, where UE(0) 404 is served by gNB(0) 412. UE(0) 404 has an OPL to TRP(j) 402, and nearby UE(1) 408 has a CL with gNB(1) 410. According to examples, the LMF 406 provides a signalling configuration (e.g. PM or PM index) for each link using the routine illustrated in FIG. 5, which is also described in more detail below. It is to be noted that the scheme of FIG. 4 and FIG. 5 differ from other schemes such as full duplex (FD), since in FD the same PRBs are used by the same NW element for both Tx and Rx, whereas in the scheme of the present disclosure PRBs are used by different NW elements and for different services (e.g. one for communication and one for positioning).

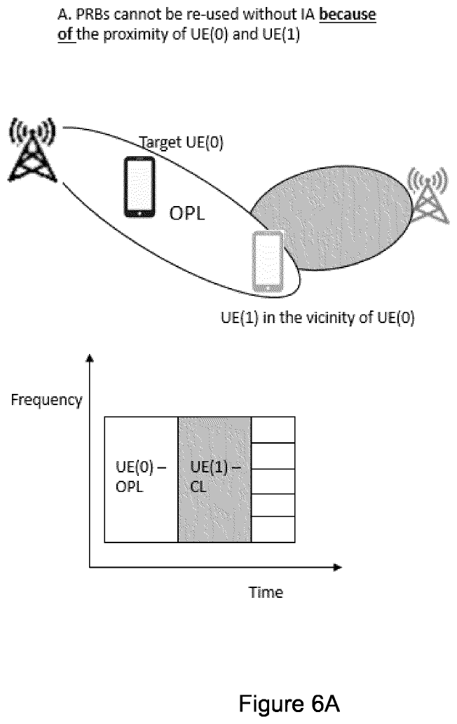

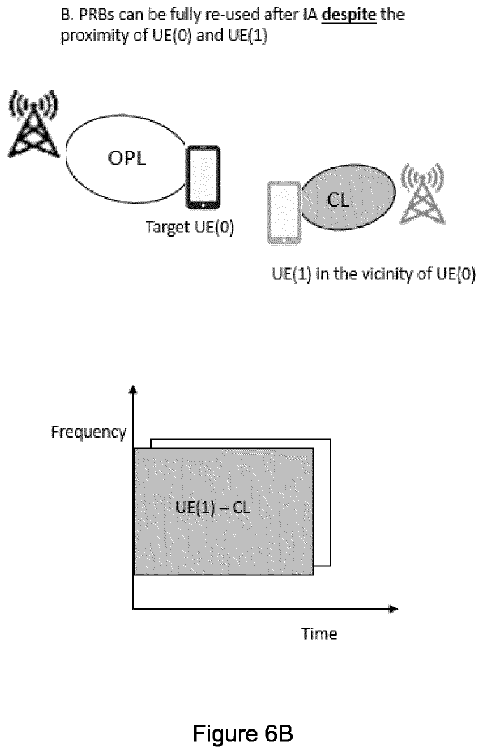

Before discussing the method of FIG. 5 in more detail, reference is first made to FIGS. 6A and 6B. FIG. 6A shows a case where PRBs are not re-used between CL and OPL. FIG. 6B shows a use case where PRBs are fully re-used for the UE(0) and UE(1) after IA, despite the fact that UE(0) and UE(1) are close to each other. In a FIG. 6B case (full PRB re-use) the LMF 406 evaluates whether the set of UEs (UE(0) 404 and UE(1) 408 in this example) are either:
Far apart enough so that they can be co-scheduled without any IA precoding.
Close enough so that they need to be interference aligned first.

According to examples, the evaluation is made around the UE that needs to be on-demand localized, i.e. target UE(0) 404 in this case.

Returning to FIG. 5, at S501 the LMF 406 obtains or acquires the precoder type and the combining capabilities of the target UE i. e UE(0) 404 in this case. For example, the LMF 406 may obtain this information from gNB(0) 412 (not shown in FIG. 5). In some examples, the obtained information includes one or more of the following regarding the target UE(0) 404: number of TX/RX antennas; TX/RX beam number; beam width. In some examples, “combining capability” of a UE may refer to operations that the UE performs to combine the signals arriving on the different RF chains. For example, combining refers to a weighted sum of all signals, where the weights may be specified in a combining matrix.

At S502, the LMF 406 acquires or obtains channel information (e.g. CSI, CIR and/or CFR, etc.) for the channel between UE(0) 404 and TRP(j) 402. In FIG. 5, one UE(0) and one TRP(j) are described for ease of explanation, but there may be the other UEs and TRPs (unshown in FIG. 5). In some examples, this may be achieved by standard LPP request/report: “LPP-Provide/Request-Info”.

At S503, the LMF 406 determines or acquires location information, such as coarse location (cl-loc) of target UE(0) 404. In some examples, the LMF 406 determines the cl-loc using information of the serving gNB (i.e. gNB(0) 412) and the report from S502. According to some examples, the coarse location estimation comprises one or more of: cell sector ID; SSB ID; CSI-RS ID; most recent TA.

At S504, the LMF 406 queries one or more base stations, such as neighbour gNBs (e.g. gNB(1) 410) to obtain data of nearby UE(s). In examples, this request is sent in an IE over NRPPa. In this example, the query is for obtaining data of UE(1) 408, which may have a CL on the same PRBs as the OPL of UE(0) 404.

At S505, gNB (in this case gNB(1) 410) evaluates the location information, such as the cl-loc. Based on the cl-loc, in this case gNB(1) 410 selects UE(1) 408.

At S506, gNB(1) 410 reports channel information (e.g. CSI) for UE(1) 408 to LMF 406. In some examples, the neighbour gNB(1) 410 reports the CSI of each CL link. In some examples, this information is sent in IE via NRPPa. In some examples, differential CSI is sent at S506 rather than full CSI. In examples, the CSI is typically acquired from DMRS (demodulation reference signals) of the same CL link, for data decoding purposes, therefore it is already available at the cell level. If, conversely, the CL has not yet been scheduled, the gNB(1) 410 may obtain CSI from ongoing control channel communication with the UE(1) 408, e.g. from PUCCH/PDCCH, SSB detection. The latter approach is already in place today, since CSI is needed for link adaptation and configuration of each CL, thus existing signalling can be used for this purpose according to some examples.

At S507, the LMF 406 evaluates CL-OPL spectral coexistence, based on received information.

Then, at S508 and once the LMF 406 possesses the channel information (e.g. CSI) of all reported links, the LMF 406 computes or determines a signalling configuration (e.g. pre-coding matrix (PM)) for each OPL. Additionally or optionally, this is performed by a selected IA method. It is to be noted that in some examples the IA algorithm is LMF-implementation specific and it may depend on several aspects, including how many simultaneous CL-OPL pairs require resolution. For example, different IA strategies may be implemented by the LMF:
For example, LMF 406 may use the CL-CSI of each of nearby UEs, i.e. H₁, H₂, . . . and choose a PM of the OPL Vₒₚₗ, so that Vₒₚₗ^{H}H₁+Vₒₚₗ^{H}H₂˜0. In this case, the OPL PM is signalled to the TRP (e.g. TRPj 402) and the target UE (e.g. UE(0) 404). In this example, H_i corresponds to the CSI of UE_i e.g. H₁ corresponds to the CSI of UE₁, H₂ corresponds to the CSI of UE₂, etc. Similarly, Vₒₚₗ corresponds to the precoding matrix associated with the positioning link of UE0, and so on.
In another example, the LMF chooses a random OPL PM Hₒₚₗ, and computes a PM for each CL V₁, V₂ so that Hₒₚₗ^{H}V₁H₁+Hₒₚₗ^{H}V₂H₂˜0 and V₁^{H}VₒₚₗHₒₚₗ+V₁^{H}V₂H₂˜0 and V₂^{H}VₒₚₗHₒₚₗ+V₂^{H}V₁H₁˜0. The superscript (·)^{H} stands for Hermitian operation.
It is also to be noted that other IA strategies that align the signals totally or partially are not excluded.

At S509, the LMF 406 sends determined signaling configuration (e.g. PM or PM index) to UE(0) 404. In other words, LMF 406 sends the signaling configuration (e.g. PM index) to OPL transmitter. This signaling configuration (e.g. PM or PM index) may be sent in IE in LPP configuration. In some examples the IE is in the form. “IA-PM-idx” in the LPP “ProvideAssistanceData” message (defined in Section 5.2.1 of TS 37.355) indexing the precoding matrix that should be used for OPL. In examples, IA-PM stands for interference alignment precoding matrix. Idx is the index. So, populating this IE with an index k for example, will cause the entity receiving the IE to apply the PM indexed k at transmission.

At S510, LMF 406 sends signaling configuration (e.g. PM or PM index, and/or CM or CM index) to gNB(1) 410. The PM or PM index, and/or CM or CM index, may be sent in IE in NRPPa configuration message, in some examples.

Then, each gNB (e.g. gNB(0) 412 and gNB(1) 410) may decide to apply the signalled signalling configuration, or reject the signalling configuration. For example, a gNB may reject a configuration where the signalling configuration would negatively influence cell and/or UE QoS. Thus, it may be considered that the gNBs assess whether each of their UEs may apply the indicated signalling configuration. For example, the gNB may assess if the signalling configuration (e.g. PM index) has been previously flagged as causing cross-link interference (CLI) or has a history or low MCS (i.e. transmission to that UE, using the indicated PM lead to frequent link-adaptations with MCS lowering). If the gNB deems the signalling configuration as suitable, then the gNB configures the data UE with the signalling configuration (e.g. PM) selected by the LMF 406 via standard serving cell configuration. In the example of FIG. 5, gNB(0) 412 implements the signalling configuration for UE(0) 404 (see S511), and gNB(1) 410 implements signalling configuration for UE(1) 408 (see S512).

It will be understood that the signalling configurations for UE(0) and UE(1) (e.g. first signalling configuration for UE(0) and second signalling configuration for UE(1))will depend on the OPL and CL channel status. In some examples (dependent on the OPL and CL channel status), the first signaling configuration is different from the second signaling configuration. In other examples (dependent on the OPL and CL channel status), the first signaling configuration is the same as the second signaling configuration.

As shown at S513, when the signalling configuration (e.g. PM) is applied, the gNB (e.g. gNB(1) 410) messages LMF 406 with an ACK. For example, this ACK may be an IE comprising a confirmation and validity duration (VD) field with a duration for which the PM will be active on the respective link. In some examples, this IE is sent on NRPPa.

It will be understood that examples using such a scheme may optimize channel capacity through full spectral reuse, while minimizing the impact of scheduling on-demand positioning resources to communication resources. This allows that both CL and OPL QoS are simultaneously met.

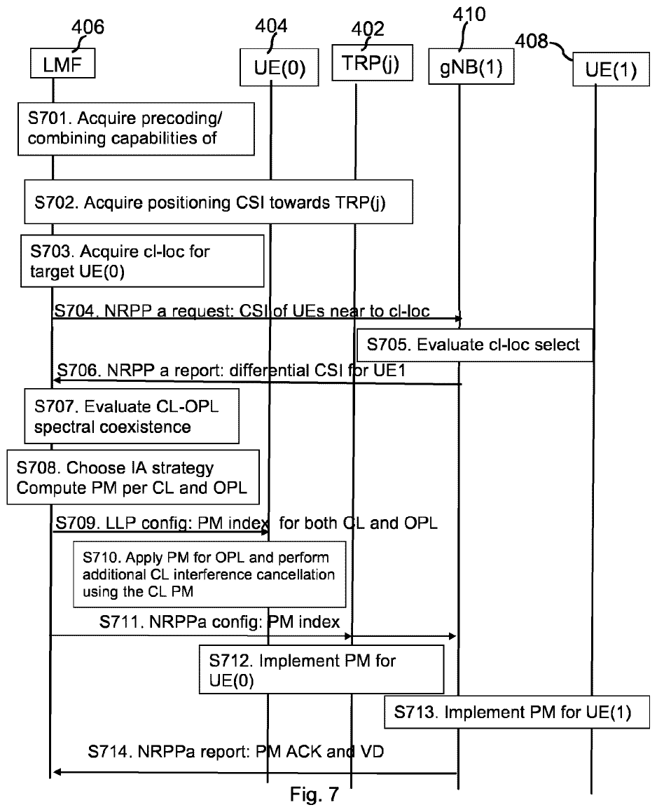

A variant, or alternative example is shown with respect to FIG. 7. In this alternative example, the LMF 406 may send to the target UE(0) 404 the signalling configuration (e.g. PM) of both OPL and CL. Therefore, in such an example, UE(0) 404 receives PM of OPL for UE(0) 404 and PM of CL of UE(1) 408. The UE(0) can then cancel (or attempt to cancel) residual interference, when the selected signalling configuration did not fully align the interference CL-OPL.

In FIG. 7, S701 to S708 are equivalent to S501 to S508 as in FIG. 5.

At S709, the LMF 406 sends to UE(0) 404 information of the signalling configuration (e.g. PM) for both CL and OPL.

Then, at S710, the UE(0) 404 applies the signalling configuration (e.g. PM) for OPL. In a situation where this does not entirely (or sufficiently) cancel interference between OPL and CL, then additional interference cancellation techniques may be employed by UE(0) 404. For example, the additional cancellation technique may comprise performing CL interference cancellation using the signalling configuration (e.g. PM) for the CL. In some examples, sequential or parallel interference cancellation receivers may be activated. In some examples, Interference rejection techniques based on MMSE (minimum mean square error) detection may also be used.

At S711, the LMF 406 sends the signalling configuration (e.g. PM) to the gNB(1) 410 and to the TRP(j) 402.

At S712, the signalling configuration is applied for UE(0) 404, using the configuration signalled at S709.

At S713, the signalling configuration is applied for UE(1) 408, using the configuration signalled at S709.

At S714, when the signalling configuration (e.g. PM) is applied, the gNB (e.g. gNB(1) 410) messages LMF 406 with an ACK. For example, this ACK may be an IE comprising a confirmation and validity duration (VD) field with a duration for which the signalling configuration will be active on the respective link. In some examples, this IE is sent on NRPPa.

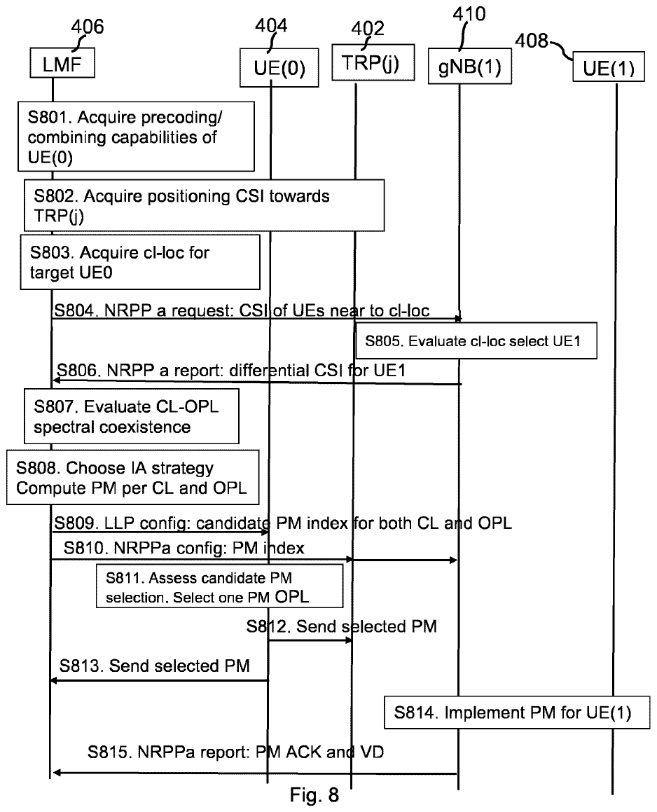

Another variant, or alternative example, is shown with respect to FIG. 8. In this example, the LMF 406 may select a list of candidate signalling configurations (e.g. PMs) for at least the target UE(0) 404. The list of candidates signalling configurations is sent to UE(0) 404 which chooses one PM to use. The UE selection of the single signalling configuration (e.g. PM) is then communicated to:
The TRP 402 via new RRC message (message 12)
The LMF 406 via new LPP IE (message 13).

In FIG. 8, S801 to S808 are equivalent to S501 to S508 in FIG. 5.

At S809, LMF 406 sends signalling configuration (e.g. PM index) for both CL and OPL to UE(0) 404.

At S810, LMF 406 sends to gNB(1) 410 and TRP(j) 402 a signalling configuration (e.g. PM/CM or PM/CM index) for UE(1) 408 and/or UE(0) 404.

At S811, the UE(0) 404 assesses and selects one of the signalling configurations it has received.

The UE(0) 404 sends information of the selected signalling configuration to the TRPj 402 (S812), and to the LMF 406 (S813).

At S814, the signalling configuration is implemented for UE(1) 408.

At S815, gNB(1) messages LMF 406 with an ACK. For example, this ACK may be an IE comprising a confirmation and validity duration (VD) field with a duration for which the signalling configuration will be active on the respective link. In some examples, this IE is sent on NRPPa.

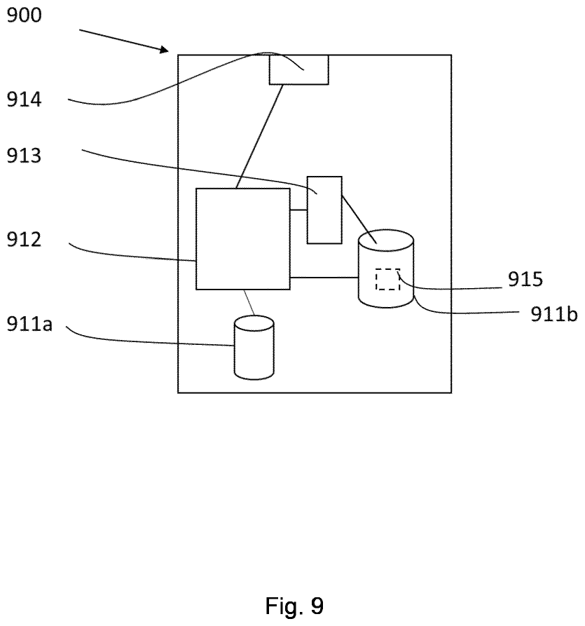

FIG. 9 illustrates an example of a control apparatus 900 for controlling a function of the described examples. The control apparatus may comprise at least one random access memory (RAM) 911a, at least one read only memory (ROM) 911b, at least one processor 912, 913 and an input/output interface 914. The at least one processor 912, 913 may be coupled to the RAM 911a and the ROM 911b. The at least one processor 912, 913 may be configured to execute an appropriate software code 915. The software code 915 may for example allow performance of one or more steps of the present aspects. The software code 915 may be stored in the ROM 911b. The control apparatus 900 may be interconnected with another control apparatus 900 controlling another function. For example, an LMF, TRP and/or gNB may comprise or be comprised in an apparatus as described with respect to FIG. 9. More specifically, the apparatus shown in FIG. 9 can be used for performing the embodiments described in FIGS. 2, 5, 7, 8, 11, and 12, for example.

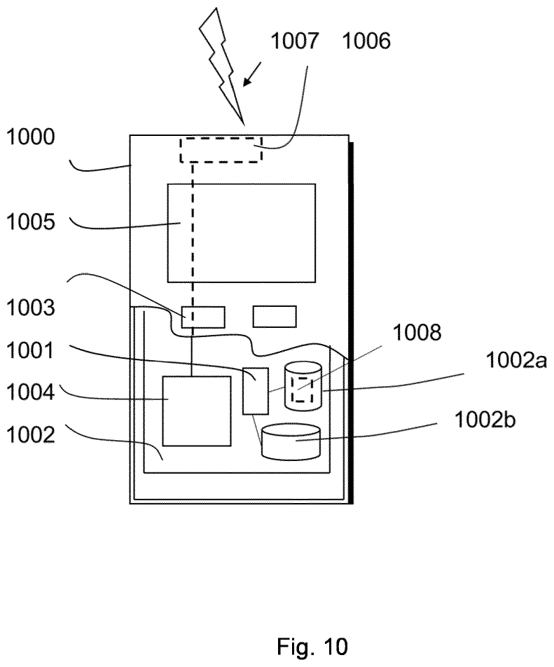

FIG. 10 illustrates an example of a terminal 1000. The terminal 1000 may be provided by any device capable of sending and receiving radio signals. Non-limiting examples comprise a user equipment or user device, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 1000 may provide, for example, communication of data for carrying communications. The communications may be one or more of voice, electronic mail (email), text message, multimedia, data, machine data and so on. The terminal 1000 may receive signals over an air or radio interface 1007 via appropriate apparatus for receiving and may transmit signals via appropriate apparatus for transmitting radio signals. In FIG. 10 transceiver apparatus is designated schematically by block 1006. The transceiver apparatus 1006 may be provided for example by means of a radio part and associated antenna arrangement. The antenna arrangement may be arranged internally or externally to the mobile device. The terminal 1000 may be provided with at least one processor 1001, at least one memory ROM 1002a, at least one RAM 1002b and other possible components 1003 for use in software and hardware aided execution of tasks it is designed to perform, including control of access to and communications with access systems and other communication devices. The at least one processor 1001 is coupled to the RAM 1002b and the ROM 1002a. The at least one processor 1001 may be configured to execute an appropriate software code 1008. The software code 1008 may for example allow to perform one or more of the presently described aspects. The software code 1008 may be stored in the ROM 1002a. The processor, storage and other relevant control apparatus can be provided on an appropriate circuit board and/or in chipsets. This feature is denoted by reference 1004. The device may optionally have a user interface such as key pad 1005, touch sensitive screen or pad, combinations thereof or the like. Optionally one or more of a display, a speaker and a microphone may be provided depending on the type of the device.

The terminal shown in FIG. 10 can be used for performing the embodiments described in FIGS. 5, 7, 8, 13, and 14, for example.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

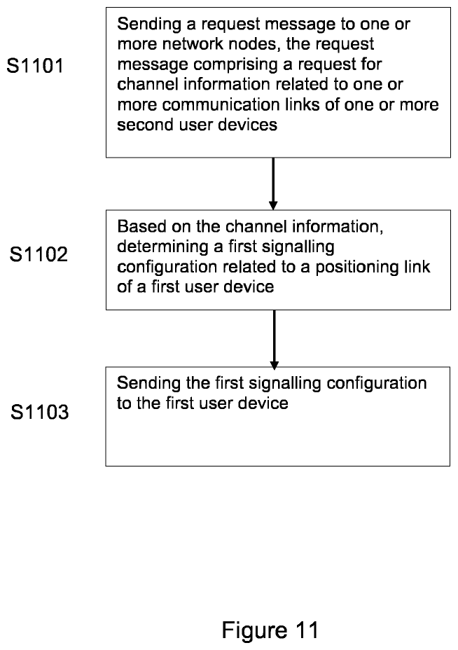

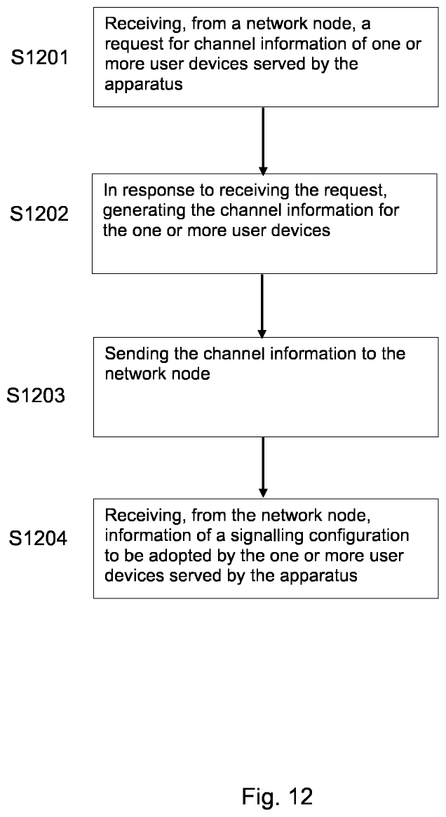

FIG. 11 is a flow chart of a method according to an example. The method of FIG. 12 is viewed from the perspective of an apparatus. For example, the apparatus may comprise a location management function.

At S1101 the method comprises sending a request message to one or more network nodes, the request message comprising a request for channel information related to one or more communication links of one or more second user devices.

At S1102 the method comprises, based on the channel information, determining a first signalling configuration related to a positioning link of a first user device.

At S1103 the method comprises sending the first signalling configuration to the first user device.

FIG. 12 is a flow chart of a method according to an example. The method of FIG. 12 is viewed from the perspective of an apparatus. For example, the apparatus may comprise a base station (gNB).

At S1201 the method comprises receiving, from a network node, a request for channel information of one or more user devices served by the apparatus.

At S1202 the method comprises, in response to receiving the request, generating the channel information for the one or more user devices.

At S1203 the method comprises sending the channel information to the network node.

At S1204 the method comprises receiving, from the network node, information of a signalling configuration to be adopted by the one or more user devices served by the apparatus.

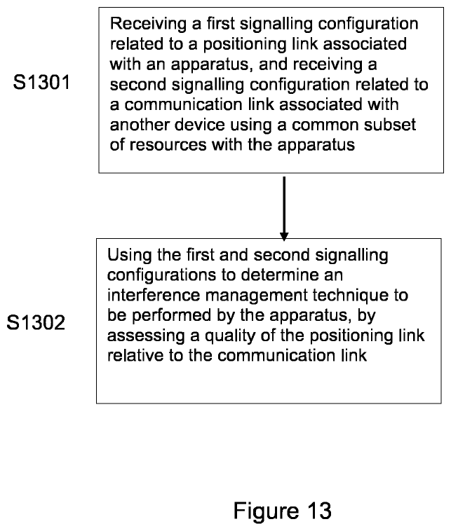

FIG. 13 is a flow chart of a method according to an example. The method of FIG. 13 is viewed from the perspective of an apparatus. For example, the apparatus may comprise a user device.

At S1301 the method comprises receiving a first signalling configuration related to a positioning link associated with an apparatus, and receiving a second signalling configuration related to a communication link associated with another device using a common subset of resources with the apparatus.

At S1302 the method comprises using the first and second signalling configurations to determine an interference management technique to be performed by the apparatus, by assessing a quality of the positioning link relative to the communication link.

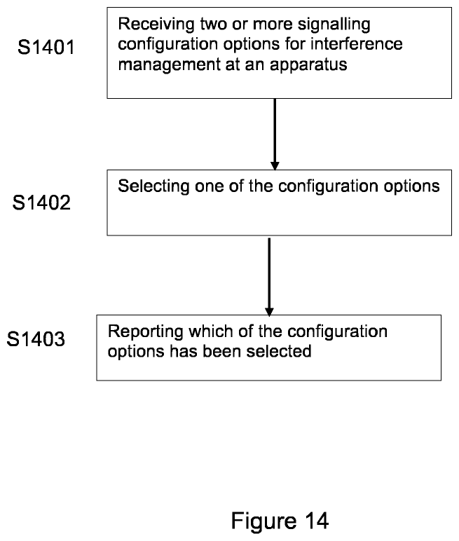

FIG. 14 is a flow chart of a method according to an example. The method of FIG. 14 is viewed from the perspective of an apparatus. For example, the apparatus may comprise a user device.

At S1401 the method comprises receiving two or more signalling configuration options for interference management at an apparatus.

At S1402 the method comprises selecting one of the configuration options.

At S1403 the method comprises reporting which of the configuration options has been selected.

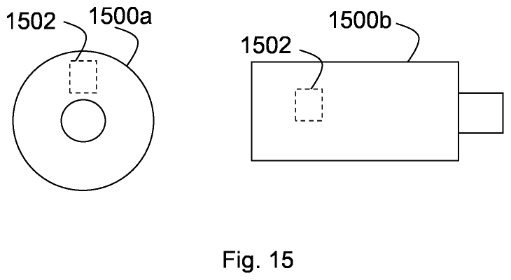

FIG. 15 shows a schematic representation of non-volatile memory media 1500a (e.g. computer disc (CD) or digital versatile disc (DVD)) and 1500b (e.g. universal serial bus (USB) memory stick) storing instructions and/or parameters 1502 which when executed by a processor allow the processor to perform one or more of the steps of the any of the methods of FIGS. 5, 7-8, and 11 to 14, for example.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. Items in lists may also be separated without the use of joining and/or wording. Such lists may, for example, start with a colon (:), and each item in the list be separated by a semi-colon (;).

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-24. (canceled)

25. An apparatus comprising:
means for sending a request message to one or more network nodes, the request message comprising a request for channel information related to one or more communication links of one or more second user devices; and
means for, based on the channel information, determining a first signalling configuration related to a positioning link of a first user device; and
means for sending the first signalling configuration to the first user device.

26. The apparatus according to claim 25, comprising means for determining one or more second signalling configurations related to the one or more communication links of the one or more second user devices, and means for sending the one or more second signalling configurations to the one or more second user devices.

27. The apparatus according to claim 26, wherein the first signalling configuration and the one or more second signalling configurations are configured for a same one or more radio resources.

28. The apparatus according to claim 26, wherein the first signalling configuration comprises a signal transformation for transmitted and/or received signals of the first user device, and the one or more second signalling configurations comprise a signal transformation for transmitted and/or received signals of the one or more second user devices, the first and second signalling configurations arranged to minimise interference between the positioning link of the first user device and the one or more communication links of the second user devices.

29. The apparatus according to claim 26, wherein the first signalling configuration includes a first precoder matrix and/or a first combining matrix, and the one or more second signalling configurations include a second precoder matrix and/or a second combining matrix.

30. The apparatus according to claim 25, wherein the channel information comprises one or more of: channel state information; channel impulse response; channel frequency response.

31. The apparatus according to claim 25, further comprising means for determining location information of the first user device, and means for using the location information to determine the one or more network nodes.

32. The apparatus according to claim 31, wherein the location information comprises one or more of: serving beam information; cell sector information; information of distance to cell edge.

33. The apparatus according to claim 25, wherein the one or more second user devices are proximate to the first user device, wherein the one or more second user devices are considered proximate if they one or more of: share a serving beam with the first user device; have a serving beam adjacent to a serving beam of the first user device; are in an adjacent cell-sector to the first user device.

34. The apparatus according to claim 25, comprising a location management function.

35. An apparatus comprising:
means for receiving, from a network node, a request for channel information of one or more user devices served by the apparatus;
means for, in response to receiving the request, generating the channel information for the one or more user devices,
means for sending the channel information to the network node;
means for receiving, from the network node, information of a signalling configuration to be adopted by the one or more user devices served by the apparatus.

36. The apparatus according to claim 35, wherein the apparatus comprises means for sending the information of a signalling configuration to the one or more user devices.

37. The apparatus according to claim 35, wherein the signalling configuration comprises a signal transformation for transmitted and/or received signals of the one or more user devices served by the apparatus.

38. The apparatus according to claim 35, wherein the signalling configuration comprises information of a precoder and/or combining matrix to be applied by the one or more user devices.

39. The apparatus according to claim 38, comprising means for sending an acknowledgement to the network node acknowledging receipt of the precoder and/or combining matrix, the acknowledgement comprising information of how many slots the precoding and/or combining matrix will be active for.

40. The apparatus according to claim 35, wherein the apparatus comprises means for, in response to receiving the request, reporting one or more of the following to the network node in an information element: the channel information; identification information of the one or more user devices served by the apparatus; information of type of link between the apparatus and the one or more user device served by the apparatus, the type of link comprising a positioning link or a communication link; information of precoding capability.

41. The apparatus according to claim 35, wherein the apparatus comprises a base station.

42. An apparatus comprising:
means for receiving a first signalling configuration related to a positioning link associated with the apparatus, and for receiving a second signalling configuration related to a communication link associated with another device using a common subset of resources with the apparatus; and
means for using the first and second signalling configurations to determine an interference management technique to be performed by the apparatus, by assessing a quality of the positioning link relative to the communication link.

43. The apparatus according to claim 42, the means for using the first and second signalling configurations to determine an interference management technique to be performed being configured to do so in response to determining that the received signalling configurations do not result in sufficient improvement in a quality of the positioning link, the interference management technique comprising removing an effect of the communication link from the positioning link.

44. The apparatus according to claim 43, wherein the first signalling configuration comprises a precoding matrix for the positioning link of the apparatus and the second signalling configuration comprises a precoding matrix for the communication link associated with the device, and the interference management technique comprises performing interference cancellation of the communication link.
